(19) United States
(12) Patent Application Publication
(10) Pub. No.: US 2013/0331161 A1
(43) Pub. Date: Dec. 12, 2013

(54) IMAGE DISPLAY SYSTEM, PUZZLE GAME SYSTEM, IMAGE DISPLAY METHOD, PUZZLE GAME METHOD, IMAGE DISPLAY DEVICE, PUZZLE GAME DEVICE, IMAGE DISPLAY PROGRAM AND NON-TRANSITORY STORAGE MEDIUM ENCODED WITH A COMPUTER-READABLE PUZZLE GAME PROGRAM

(71) Applicant: NINTENDO CO., LTD., Kyoto (JP)

(72) Inventors: Satoshi KIRA, Kyoto (JP); Masahiko MASHIMO, Kyoto (JP); Kaname WADA, Suginami-ku (JP); Koichi NIIDA, Suginami-ku (JP); Naoki SAKAMOTO, Suginami-ku (JP)

(73) Assignee: NINTENDO CO., LTD., Kyoto (JP)

(21) Appl. No.: 13/657,097

(22) Filed: Oct. 22, 2012

(30) Foreign Application Priority Data
Jun. 11, 2012 (JP) 2012-131758

(51) Int. Cl. G06T 15/00; A63F 13/00

(52) U.S. Cl. 463/9; 345/419

(57) ABSTRACT

An image display system that has access to a display unit capable of stereoscopic display is provided. The image display system includes a background setting unit for setting a two-dimensional stereo image for stereoscopic view as a background; a reference surface setting unit for setting a reference surface in a virtual space such that the reference surface corresponds to a pseudo-surface that appears to exist in the two-dimensional stereo image when the two-dimensional stereo image is stereoscopically displayed; an object placing unit for placing at least an object on the reference surface; a stereoscopic image creating unit for creating an image for stereoscopic view, based on a stereo image created by picking-up an image of the object using a stereo virtual camera in the virtual space and on the two-dimensional stereo image; and a display control unit for causing the display unit to display the image for stereoscopic view.

This nonprovisional application is based on Japanese Patent Application No. 2012-131758 filed on Jun. 11, 2012 with the Japan Patent Office, the entire contents of which are hereby incorporated by reference.

### FIELD

The invention generally relates to an image display system having access to a display unit capable of stereoscopic display and a puzzle game system utilizing the same, an image display method and a puzzle game method utilizing the same, an image display device and a puzzle game device utilizing the same, and a non-statutory storage medium encoded with a computer-readable image display program and a puzzle game program.

### BACKGROUND AND SUMMARY

Conventionally, various information processing techniques utilizing stereoscopic display have been known.

With progress in technologies related to processing devices such as processors and various display devices, it has become easier to generate images for providing stereoscopic display, using a plurality of images.

Exemplary embodiments provide a new image display system presenting a stereoscopic display using a plurality of images, a puzzle game system, an image display method, a puzzle game method, an image display device, a puzzle game device, a non-transitory storage medium encoded with a computer-readable image display program and a puzzle game program.

An exemplary embodiment provides an image display system having access to a display unit capable of stereoscopic display. The image display system includes: a background setting unit for setting a two-dimensional stereo image for stereoscopic view as a background; a reference surface setting unit for setting a reference surface in a virtual space such that the reference surface corresponds to a pseudo-surface that appears to exist in the two-dimensional stereo image when the two-dimensional stereo image is stereoscopically displayed; an object placing unit for placing at least an object on the reference surface; a stereoscopic image creating unit for creating an image for stereoscopic view, based on a stereo image created by picking-up an image of the object using a stereo virtual camera in the virtual space and on the two-dimensional stereo image; and a display control unit for causing the display unit to display the image for stereoscopic view.

According to the exemplary embodiment, a stereoscopic display with high degree of freedom can be realized, using a two-dimensional stereo image set on a background obtained in advance and a stereo image created dynamically from an object arranged in a virtual space.

In an exemplary embodiment, the image display system further includes an object control unit for moving the object on the reference surface. According to the exemplary embodiment, application to game production is easy, as the object is movable.

In an exemplary embodiment, the two-dimensional stereo image is obtained from an image including the pseudo-surface by representing from an oblique direction with respect to the pseudo-surface; the pseudo-surface appears to be inclined with respect to a display screen of the display unit when the two-dimensional stereo image is stereoscopically displayed; and the reference surface setting unit is adapted to set the reference surface along the inclination of the pseudo-surface. According to the exemplary embodiment, even when the two-dimensional stereo image set on the background does not seem flat when viewed stereoscopically, natural stereoscopic display can be realized by arranging the object at an appropriate position.

In an exemplary embodiment, the two-dimensional stereo image includes an image representing at least one of the ground and a floor. According to the exemplary embodiment, the two-dimensional stereo image set as the background can be used as an image representing the ground or a floor.

In an exemplary embodiment, the two-dimensional stereo image is an image picked-up by a stereo camera. According to the exemplary embodiment, any two-dimensional stereo image picked-up by the user or the like using a stereo camera may be set as the background.

In an exemplary embodiment, the two-dimensional stereo image is an image created by a process of modifying one image. According to the exemplary embodiment, stereoscopic display can easily be realized using an image from a single point of view.

An exemplary embodiment provides a puzzle game system having access to a display unit capable of stereoscopic display. The puzzle game system includes: a background setting unit for setting a two-dimensional stereo image for stereoscopic view as a background; a reference surface setting unit for setting a reference surface in a virtual space such that the reference surface corresponds to a pseudo-surface that appears to exist in the two-dimensional stereo image when the two-dimensional stereo image is stereoscopically displayed; a game processing unit for placing a plurality of puzzle pieces on the reference surface; a stereoscopic image creating unit for creating an image for stereoscopic view, based on a stereo image created by picking-up an image of the puzzle pieces using a stereo virtual camera in the virtual space and on the two-dimensional stereo image; and a display control unit for causing the display unit to display the image for stereoscopic view. The game processing unit is adapted to erase the puzzle piece in accordance with progress of the game.

According to the exemplary embodiment, a puzzle game with high degree of freedom can be realized, using a two-dimensional stereo image set on a background obtained in advance and a stereo image created dynamically from a puzzle piece arranged in the virtual space. Further, since any puzzle piece can be arranged on the pre-set background image, an amount of calculation in the drawing process for realizing the stereoscopic display can be reduced.

An exemplary embodiment provides an image display method on a display unit capable of stereoscopic display. The image display method includes: the background setting step of setting a two-dimensional stereo image for stereoscopic view as a background; the reference surface setting step of setting a reference surface in a virtual space such that the reference surface corresponds to a pseudo-surface that appears to exist in the two-dimensional stereo image when the two-dimensional stereo image is stereoscopically displayed; the object placing step of placing at least an object on the reference surface; the stereoscopic image creating step of creating an image for stereoscopic view, based on a stereo image created by picking-up an image of the object using a stereo virtual camera in the virtual space and on the two-dimensional stereo image; and the display control step of causing the display unit to display the image for stereoscopic view.

In an exemplary embodiment, the image display method further includes the object control step of moving the object on the reference surface.

In an exemplary embodiment, the two-dimensional stereo image is obtained from an image including the pseudo-surface by representing from an oblique direction with respect to the pseudo-surface; the pseudo-surface appears to be inclined with respect to a display screen of the display unit when the two-dimensional stereo image is stereoscopically displayed; and the reference surface setting step includes the step of setting the reference surface along the inclination of the pseudo-surface.

In an exemplary embodiment, the two-dimensional stereo image includes an image representing at least one of the ground and a floor.

In an exemplary embodiment, the two-dimensional stereo image is an image picked-up by a stereo camera.

In an exemplary embodiment, the two-dimensional stereo image is an image created by a process of modifying one image.

An exemplary embodiment provides a puzzle game method. The puzzle game method includes: the background setting step of setting a two-dimensional stereo image for stereoscopic view as a background; the reference surface setting step of setting a reference surface in a virtual space such that the reference surface corresponds to a pseudo-surface that appears to exist in the two-dimensional stereo image when the two-dimensional stereo image is stereoscopically displayed; the game processing step of placing a plurality of puzzle pieces on the reference surface; the stereoscopic image creating step of creating an image for stereoscopic view, based on a stereo image created by picking-up an image of the object using a stereo virtual camera in the virtual space and on the two-dimensional stereo image; and the display control step of causing the display unit to display the image for stereoscopic view. The game processing step includes the step of erasing the puzzle piece in accordance with prescribed progress of the game.

An exemplary embodiment provides an image display device. The image display device includes: a display unit capable of stereoscopic display; a background setting unit for setting a two-dimensional stereo image for stereoscopic view as a background; a reference surface setting unit for setting a reference surface in a virtual space such that the reference surface corresponds to a pseudo-surface that appears to exist in the two-dimensional stereo image when the two-dimensional stereo image is stereoscopically displayed; an object placing unit for placing at least an object on the reference surface; a stereoscopic image creating unit for creating an image for stereoscopic view, based on a stereo image created by picking-up an image of the object using a stereo virtual camera in the virtual space and on the two-dimensional stereo image; and a display control unit for causing the display unit to display the image for stereoscopic view.

An exemplary embodiment provides a puzzle game device. The puzzle game device includes: a display unit capable of stereoscopic display; a background setting unit for setting a two-dimensional stereo image for stereoscopic view as a background; a reference surface setting unit for setting a reference surface in a virtual space such that the reference surface corresponds to a pseudo-surface that appears to exist in the two-dimensional stereo image when the two-dimensional stereo image is stereoscopically displayed; a game processing unit for placing a plurality of puzzle pieces on the reference surface; a stereoscopic image creating unit for creating an image for stereoscopic view, based on a stereo image created by picking-up an image of the puzzle pieces using a stereo virtual camera in the virtual space and on the two-dimensional stereo image; and a display control unit for causing the display unit to display the image for stereoscopic view. The game processing unit is adapted to erase the puzzle piece in accordance with prescribed progress of the game.

An exemplary embodiment provides a non-transitory storage medium encoded with a computer-readable image display program and executable by a computer having access to a display unit capable of stereoscopic display. The image display program causes the computer to execute: the background setting step of setting a two-dimensional stereo image for stereoscopic view as a background; the reference surface setting step of setting a reference surface in a virtual space such that the reference surface corresponds to a pseudo-surface that appears to exist in the two-dimensional stereo image when the two-dimensional stereo image is stereoscopically displayed; the object placing step of placing at least an object on the reference surface; the stereoscopic image creating step of creating an image for stereoscopic view, based on a stereo image created by picking-up an image of the object using a stereo virtual camera in the virtual space and on the two-dimensional stereo image; and the display control step of causing the display unit to display the image for stereoscopic view.

An exemplary embodiment provides a non-transitory storage medium encoded with a computer-readable puzzle game program. The puzzle game program is executable by a computer having access to a display unit capable of stereoscopic display. The puzzle game program causes the computer to execute: the background setting step of setting a two-dimensional stereo image for stereoscopic view as a background; the reference surface setting step of setting a reference surface in a virtual space such that the reference surface corresponds to a pseudo-surface that appears to exist in the two-dimensional stereo image when the two-dimensional stereo image is stereoscopically displayed; the game processing step of placing a plurality of puzzle pieces on the reference surface; the stereoscopic image creating step of creating an image for stereoscopic view, based on a stereo image created by picking-up an image of the object using a stereo virtual camera in the virtual space and on the two-dimensional stereo image; and the display control step of causing the display unit to display the image for stereoscopic view; wherein the game processing step includes the step of erasing the puzzle piece in accordance with prescribed progress of the game.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an exemplary illustrative non-limiting hardware configuration of the game machine according to an exemplary embodiment.

FIG. 2 shows an exemplary illustrative non-limiting schematic diagram representing an outline of the image display method according to an exemplary embodiment.

FIGS. 3 and 4 show an exemplary illustrative non-limiting example of a puzzle game provided by the game machine according to an exemplary embodiment.

FIGS. 5A and 5B show exemplary illustrative non-limiting schematic diagrams representing the process for creating images for stereoscopic view by the image display method according to an exemplary embodiment.

FIG. 6 shows an exemplary illustrative non-limiting flowchart illustrating the overall process procedure of the image display method according to an exemplary embodiment.

FIGS. 7A to 7C show exemplary illustrative non-limiting schematic diagrams representing the process related to setting of a reference plane inclination/determination of object arranging position according to an exemplary embodiment.

### DETAILED DESCRIPTION OF NON-LIMITING EXAMPLE EMBODIMENTS

Some embodiments will be described in detail with reference to the drawings. The same or corresponding pieces in the drawings have the same reference characters allotted and description thereof will not be repeated.

### A. Embodiments

The image display system in accordance with a typical embodiment is realized by a computer having a processor or the like mounted thereon. The image display system has access to a display unit capable of stereoscopic display. That it “has access to” the display unit capable of stereoscopic display encompasses a configuration that the image display system has the display unit capable of stereoscopic display built therein, as well as a configuration that images for stereoscopic view (typically, two-dimensional stereo images) are output to a display unit capable of stereoscopic display provided outside the image display system and stereoscopic display is realized on the display unit.

Such an image display system may be implemented as a portable or a stationary game device, a personal computer, a portable telephone, a smart phone, a PDA (personal digital assistance) or the like. Another embodiment implements an image display program executable by a computer that has access to a display unit capable of stereoscopic display.

A further embodiment implements an image display device including a display unit capable of stereoscopic display. A still further embodiment implements an image display method executed by a display unit capable of stereoscopic display and a controller body that has access to the display device in cooperation with each other.

An application as a puzzle game system capable of providing a puzzle game utilizing information processing related to such stereoscopic display is also possible. Then, an embodiment may implement a puzzle game program executable by a computer that has access to a display unit capable of stereoscopic display. Implementation as a puzzle game device including a display device capable of stereoscopic display is also possible. Further, an implementation as a puzzle game method executed by a display unit capable of stereoscopic display and a controller body that has access to the display device in cooperation with each other is also possible.

In the following, as a typical example of the image display system (or image display device) or the puzzle game system (or puzzle game device) in accordance with an embodiment, implementation as a game machine 1 will be described.

### B. Hardware Configuration

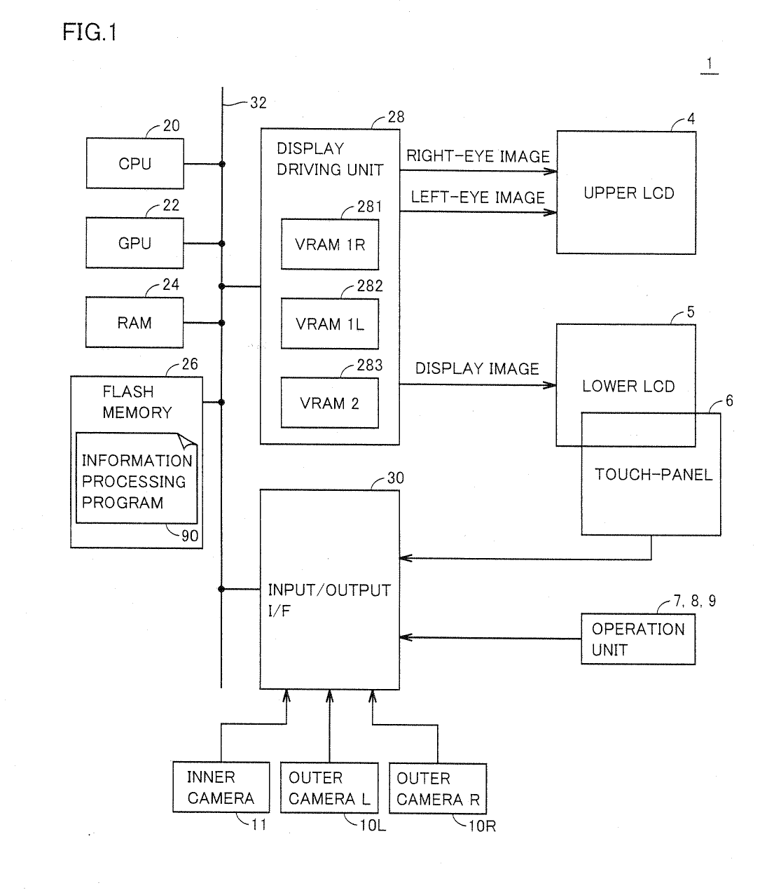

Referring to FIG. 1, hardware configuration of game machine 1 in accordance with the present embodiment will be described.

Game machine 1 has an upper housing 2 and a lower housing 3, formed to be foldable, and has an appropriate size to be portable by a user. On upper housing 2, an LCD (Liquid Crystal Display) 4 is provided as a display unit (display device) capable of stereoscopic display. As a specific example of upper LCD 4, a parallax barrier type display device may be adopted. As an alternative, a lenticular type or active shutter glasses type (time-divisional) display device may be adopted. As will be described later, as right-eye and left-eye images are provided on upper LCD 4, a stereoscopic image is presented to the user.

On lower housing 3, a lower LCD 5 is provided as a display unit (display device). Though a display device capable of stereoscopic display may be adopted as lower LCD 5, in the present embodiment, a device capable of non-stereoscopic (planar) display of objects and various pieces of information is sufficient. Therefore, a common display device is used. Further, in association with lower LCD 5, a touch panel 6 is provided as an input unit (input means). Typically, a resistive or capacitance type pointing device is adopted as touch-panel 6.

On lower housing 3, a group of buttons 7, a cross button 8, and a control pad 9 are provided as an operation unit (operating means) allowing the user to carry out various operations. Further, a power button and buttons for other operations are provided.

Game machine 1 has an inner camera 11 and outer cameras 10R and 10L as image pick-up devices (image pick-up means) for picking up an image of a target object, provided on upper housing 2. As will be described later, game machine 1 provides stereoscopic display on upper LCD 4, using input images created by image pick-up by any of the cameras. Though outer cameras 10R and 10L are capable of functioning as so-called stereoscopic cameras, when the function of stereoscopic display in accordance with the present embodiment is to be executed, only one of outer cameras 10R and 10L is activated.

More specifically, game machine 1 includes, as main hardware, a CPU (Central Processing Unit) 20, a GPU (Graphical Processing Unit) 22, an RAM (Random Access Memory) 24, a flash memory 26, a display driving unit 28, and an input/output interface (I/F) 30. These components are connected to each other by means of a bus 32.

CPU 20 is a processor serving as a main processing body, for executing various control operations in game machine 1. GPU 22 executes, in cooperation with CPU 20, processes necessary for display on upper LCD 4 and lower LCD 5. RAM 24 functions as a working memory for storing parameters and data necessary for CPU 20 and GPU 22 to execute programs. Flash memory 26 stores an information processing program 90 executed by CPU 20 and various parameters set by the user, in non-volatile manner. It is noted that in place of image display program 90, a puzzle game program including the contents of image display program 90 may be stored.

Display driving unit 28 issues driving commands for displaying images on upper LCD 4 and lower LCD 5. Display driving unit 28 applies signals for displaying the right-eye and left-eye images to upper LCD 4 capable of stereoscopic display, and applies a signal for displaying a display image to lower LCD 5. Display driving unit 28 includes VRAMs (Video Random Access Memories) 281 and 282 (VRAM 1R and VRAM 1L) for temporarily storing data representing the right-eye and left-eye images to be applied to upper LCD 4 and a VRAM 283 (VRM2) for temporarily storing data representing the display image to be applied to lower LCD 5, in accordance with, for example, a rendering instruction from CPU 20 and/or GPU 22.

Input/output interface 30 receives user operations through touch-panel 6 and operation unit (group of buttons 7, cross button 8, control pad 9) as the input unit (input means), and outputs the contents of operations to CPU 20. Further, input/output interface 30 receives image data picked-up by outer cameras 10R and 10L as well as inner camera 11, and outputs the image data to CPU 20. Further, input/output interface 30 is connected to an indicator, a speaker and the like, not shown, and provides light and sound to the user.

Outer cameras 10R and 10L and inner camera 11 include an image pick-up device such as a CCD (Charge Coupled Device) and a CMOS image sensor, and a peripheral circuit for reading image data acquired by the image pick-up device.

### C. Process Outline

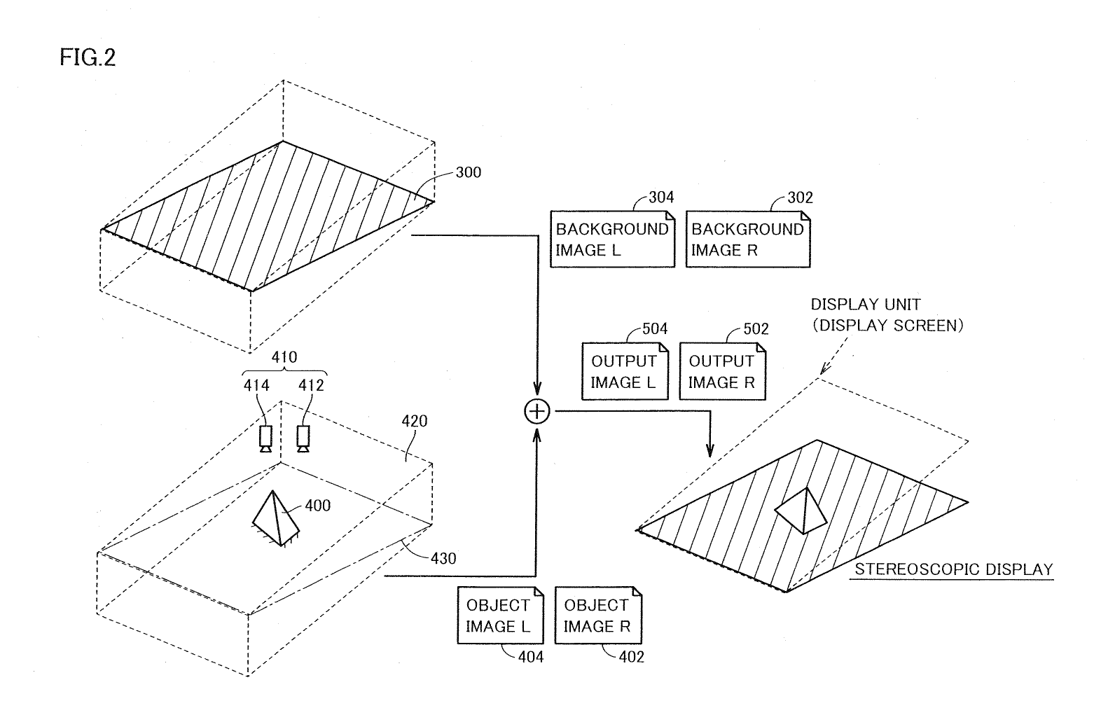

Next, referring to FIG. 2, contents of processing by the image display method in accordance with the present embodiment will be outlined. The image display method of the present embodiment is directed to display control on a display unit capable of stereoscopic display.

Referring to FIG. 2, in the present embodiment, a background image 300 as two-dimensional stereo image for stereoscopic view (right-eye background image 302 and left-eye background image 304) is combined with a stereo image (right-eye object image 402 and left-eye object image 404) created by picking-up an image of an object 400 placed in a virtual space 420 by a stereo virtual camera 410, whereby a stereoscopic display is realized on the display unit.

(1) Background Image

Background image 300 as two-dimensional stereo image for stereoscopic view is set as the background. In the example shown in FIG. 2, the two-dimensional stereo image appears as if its surface gradually goes deeper from the lower left corner to the upper right corner of the figure. Such a stereoscopic shape is not limiting, and background image 300 having any stereoscopic shape may be used.

Namely, background image 300 is a two-dimensional stereo image presenting an image including a surface (that is, exposed surface), represented from an oblique direction of the surface. The surface appears to be inclined with respect to the display screen of the display unit when background image 300 is displayed stereoscopically. Background image 300 as such includes an image representing at least one of the ground and the floor. Alternatively, background image 300 may include an image representing the sky or clouds. By using such background image 300, the amount of processing related to rendering or the like can be reduced when display is controlled such that an object such as a game character is moved as the game proceeds. Background image 300 shown in FIG. 2 represents that it appears as if it exists there when viewed stereoscopically, and it is not the case that the image object is actually arranged on the corresponding position in the virtual space. In the following description, however, background image 300 may be described as existing on that position, for convenience.

Background image 300 as such may be created or obtained by any method. By way of example, a target object to be the background image may be picked-up by a stereo camera to create background image 300. Alternatively, from an image of a target object to be the background image, a pair of two-dimensional stereo images having a prescribed parallax with each other may be created, to provide background image 300. Specifically, background image 300 may be created by a process of modifying one image.

(2) Stereo Images for Providing Stereoscopic Display of an Object

An object 400 is placed at a position where object 400 appears to be existing on a surface of background image 300 set as the background. More specifically, object 400 is placed on a position related to the surface of background image 300, and object 400 placed as such is subjected to image pick-up, so that a stereo image (right-eye object image 402 and left-eye object image 404) is created.

More specifically, to correspond to a pseudo-surface (typically, the exposed upper surface) of background image 300 that appears as if it exists when background image 300 as two-dimensional stereo image is displayed stereoscopically, a reference surface 430 is set in virtual space 420. Here, reference surface 430 is set to correspond to have the inclination corresponding to that of background image 300. At least one object 400 is placed on reference surface 430. Further, by picking-up an image of object 400 using stereo virtual camera 410 (right virtual camera 412 and left virtual camera 414) in virtual space 420, a stereo image (right-eye object image 402 and left-eye object image 404) is created.

(3) Stereoscopic Display

Based on the stereo image (right-eye object image 402 and left-eye object image 404) created by stereo virtual camera 410 (right virtual camera 412 and left virtual camera 414) and on background image 300, images for stereoscopic view (right-eye output image 502 and left-eye output image 504) are created. Specifically, from right-eye background image 302 and right-eye object image 402, right-eye output image 502 is created, and from left-eye background image 304 and left-eye object image 404, left-eye output image 504 is created, respectively. Thus created images for stereoscopic view are displayed on the display unit. As a result, on the display device, stereoscopic display is presented. Specifically, to the user, it seems as if the object exists (is standing) on the surface of background image 300.

(4) Object Movement

By appropriately moving object 400 as such, various applications are realized. Specifically, a function to move object 400 on reference surface 430 may be added. As an example, object 400 may be moved along a predetermined track.

As an example of such application, a puzzle game function may be provided on game machine 1. More specifically, in a puzzle game, a plurality of puzzle pieces are displayed as a plurality of objects 400, and each puzzle piece (each object 400) is moved in accordance with a prescribed manner of progress of the game. If any predetermined condition related to one or a plurality of puzzle pieces is satisfied, a process such as erasing the corresponding puzzle piece or increasing a puzzle piece is executed.

### D. Example of Puzzle Game

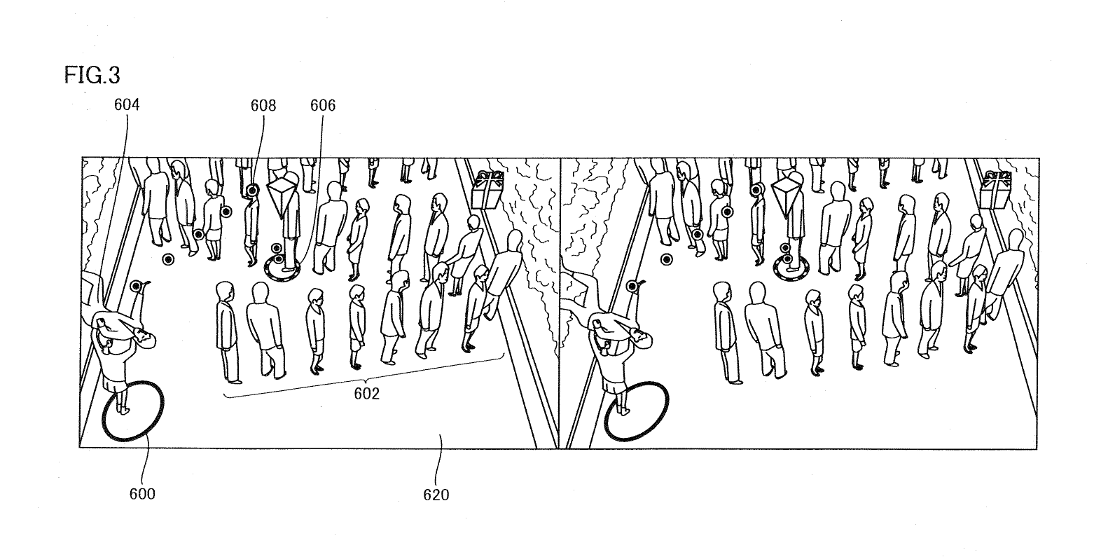

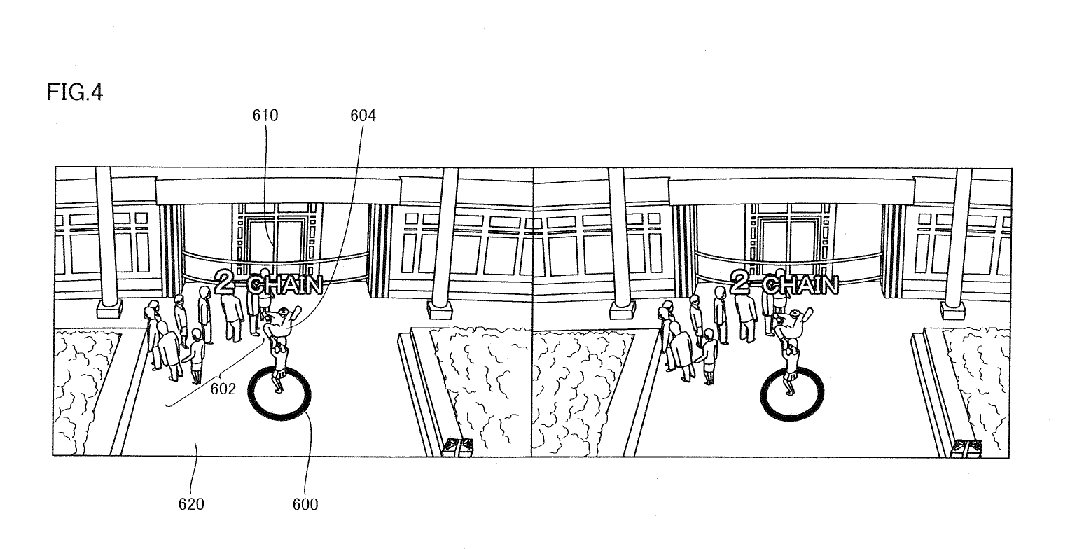

Next, referring to FIGS. 3 and 4, an example of the puzzle game executed by game machine 1 will be described. FIGS. 3 and 4 show images for stereoscopic view (right-eye output image 502 and left-eye output image 504) displayed on the display unit. There is a parallax between these images, to realize stereoscopic display.

In the puzzle game shown in FIGS. 3 and 4, a plurality of characters 620 as puzzle pieces (objects) are arranged in line along a prescribed track, and each character 602 has a puzzle attribute given thereto. Difference in puzzle attribute can be distinguished from colors, attire and the like.

The user operates a user character 600 and inserts a character 604 allocated at random to any position. If a predetermined condition with respect to characters 602 is satisfied by the insertion of character 604, character 602 and/or character 604 is erased. An example of the condition is that three or more characters 602/604 having the same puzzle attribute are placed side by side.

The position where character 604 is inserted may be appropriately set by the user, by operating touch panel 6 and/or operation unit (group of buttons 7, cross button 8, control pad 9). The position where character 604 is inserted is indicated by a position marker 606 and a track marker 608.

As the user successively erases characters 602, the scope of display is successively scrolled upward of the figure, and if, eventually, a game end position 610 shown in FIG. 4 is reached, that is, if all characters 602 are erased, the game successfully ends.

Background image 300 shown in FIG. 2 is used for representing the ground 620 shown in FIGS. 3 and 4. When background image 300 such as shown in FIG. 2 is used and the game end position 610 is set at the deepest position, as the game proceeds, the plurality of characters 602 as puzzle pieces (objects) come to be displayed at deeper positions from the screen. Here, the distance from background image 300 to stereo virtual camera 410 becomes longer (further) as the game proceeds and, therefore, broader range comes to be included in the field of view. Therefore, as can be seen from comparison of FIGS. 3 and 4, the size and the appearance of the plurality of characters 602 as the puzzle pieces (objects) change successively as the game proceeds.

### E. Process for Creating Images for Stereoscopic View

(e1: Initial Setting)

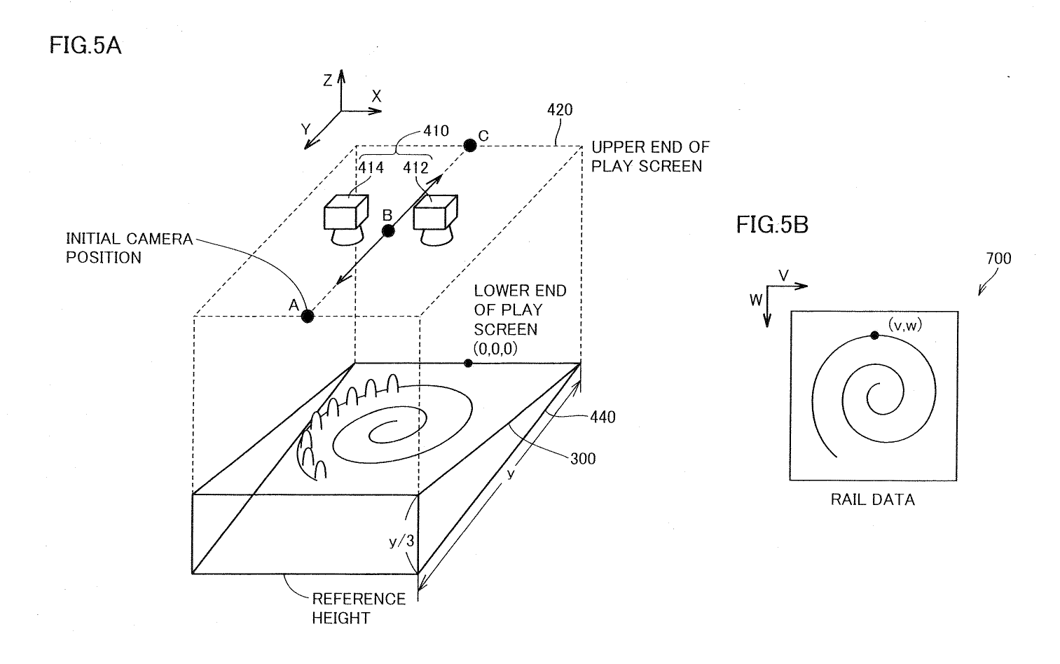

FIG. 5A schematically shows the process for creating the stereo image (right-eye object image 402 and left-eye object image 404) by picking-up an image of object 400 placed in virtual space 420 by stereo virtual camera 410. FIG. 5B shows an example of rail data 700 defining a track for moving object 400. In the present embodiment, it is assumed that object 400 moves along the track (rail) defined by rail data 700. Such rail data 700 is effective when objects as puzzle pieces (characters 602) shown in FIGS. 3 and 4 are moved and displayed. The track defined by rail data 700 can be set arbitrarily.

As shown in FIG. 5A, as an example, virtual space 420 is defined with respect to a reference bottom surface 440 set at a reference height. The value in the Z-axis direction of reference bottom surface 440 is also referred to as a reference height of background surface. Further, an upper end border where rendering of an image is possible, which corresponds to the game end position 610 shown in FIG. 4, is set as an upper end position of play screen, while a lower end border where rendering of an image is possible at the start of the game is set as the initial camera position. Reference surface 430 corresponding to background image 300 is arranged between the initial camera position and the upper end position of play screen. Reference surface 430 has a prescribed angle with respect to reference bottom surface 440. X and Y coordinates are allocated to a plane parallel to reference surface 430, and an axis vertical to the reference surface 430 is defined as the Z axis.

It is assumed that stereo virtual camera 410 (right virtual camera 412 and left virtual camera 414) is arranged at an upper portion of virtual space 420, and moves in a direction parallel to the Y-axis as the game proceeds. Specifically, stereo virtual camera 410 moves from the initial camera position (position A) at the start of the game to position B and further to position C. Further, in virtual space 420, the central portion at the upper end of reference bottom surface 440 is defined to be the origin (0, 0, 0). The direction of camera movement is only an example, and the camera may be moved in any direction.

As shown in FIG. 5A, background image 300 is inclined with respect to the display screen of display unit and, in the present embodiment, it is assumed that the inclination is ⅓ of the length in Y-axis direction (mapping length). In the following, the inclination of background image 300 is defined as change in Z-axis direction/change in Y-axis direction, of which value is represented as inclination A.

The inclination of reference surface 430 is appropriately set in accordance with the position of stereo virtual camera 410 and the inclination of background image 300 (given parallax). Further, the inclination need not be uniform. If background image 300 with ups and downs or wavy shape is used, reference surface 430 also comes to include corresponding ups and downs or wavy shape.

Further, as shown in FIG. 5B, V axis and W axis are defined for the rail data. The V axis is parallel to the X axis of virtual space 420, and the W axis is parallel to the Y axis of virtual space 420.

In the present embodiment, stereo virtual camera 410 (right virtual camera 412 and left virtual camera 414) moves in virtual space 420 as the game proceeds. As stereo virtual camera 410 moves, relative distance to reference surface 430 changes. Specifically, the size of an area on reference surface 430 included in the field of view of stereo virtual camera 410 changes. Therefore, in accordance with the size of the area included in the field of view of stereo virtual camera 410, the inclination of reference surface 430 viewed from stereo virtual camera 410 is determined, and then the position of placing object 400 is determined in accordance with rail data 700.

In the following, details of the process in accordance with the image display method will be described.

(e2: Process Steps)

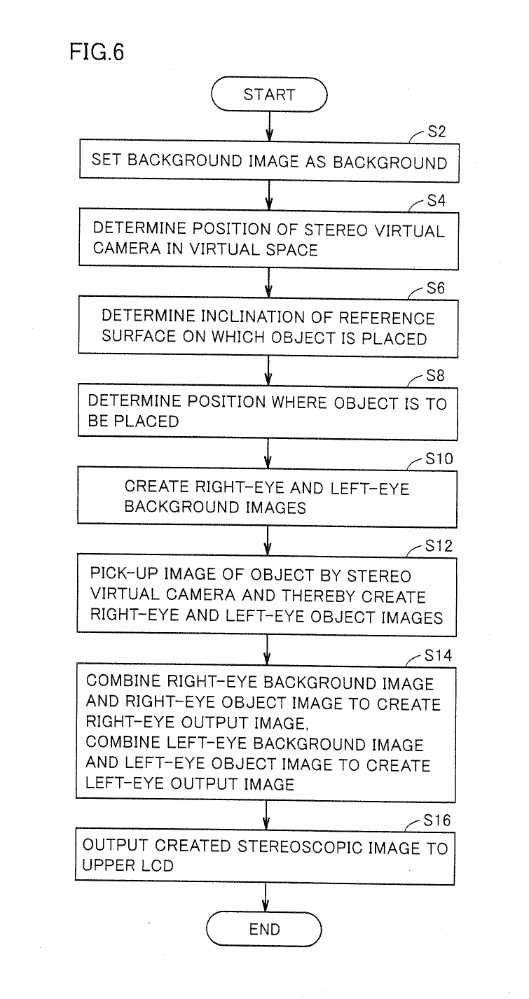

The process steps shown in FIG. 6 are typically realized by CPU 20 of game machine 1 executing a program. The program executed by game machine 1 may not be a single program, and it may be executed utilizing, for example, a library provided by the OS (Operating System).

Referring to FIG. 6, CPU 20 of game machine 1 sets background image 300, which is a two-dimensional stereo image for stereoscopic view, as the background (step S2). Specifically, CPU 20 develops data of background image 300 in a buffer memory or the like for the rendering process. Then, CPU 20 determines the position of stereo virtual camera 410 in virtual space 420 (step S4).

Thereafter, CPU 20 determines inclination of reference surface 430 on which object 400 is to be placed (step S6). Specifically, CPU 20 functions as a reference surface setting means for setting reference surface 430 in virtual space 420 such that it corresponds to a pseudo-surface that appears to exist in background image 300. Then, based on the determined inclination of reference surface 430 and rail data 700, CPU 200 determines a position where object 400 is to be placed (step S8). Specifically, CPU 20 places at least one object on reference surface 430.

Thereafter, CPU 20 creates a right-eye background image 302 and a left-eye background image 304 by rendering (rendering process) background image 300 (step S10), and by picking up an image of object 400 placed in virtual space 420 using stereo virtual camera 410, creates a right-eye object image 402 and a left-eye object image 404 (step S12). Then, CPU 20 combines right-eye background image 302 and right-eye object image 402 to create a right-eye output image 502, and combines left-eye background image 304 and left-eye object image 404 to create a left-eye output image 504 (step S14). Specifically, CPU 20 functions as a stereoscopic image creating means for creating the stereoscopic image (right-eye output image 502 and left-eye output image 504) based on the stereo images (right-eye object image 402 and left-eye object image 404) created by picking-up an image of object 400 by stereo virtual camera 410 in virtual space 420 and background image 300 (right-eye background image 302 and left-eye background image 304).

Finally, CPU 20 outputs the created stereoscopic images (right-eye output image 502 and left-eye output image 504) as the right-eye and left-eye images to upper LCD 4 (FIG. 1) (step S16). Thus, stereoscopic display is presented on upper LCD 4. Specifically, CPU 20 functions as display control means for causing upper LCD 4 as the display unit to display the stereoscopic image (right-eye output image 502 and left-eye output image 504).

Then, the process at this time point ends.

(e3: Setting of Reference Surface Inclination/Determination of Object Placement Position)

Next, the process (step S6) for determining the inclination of reference surface 430 on which object 400 is placed, and the process (step S8) for determining the position to place object 400 will be described in greater detail.

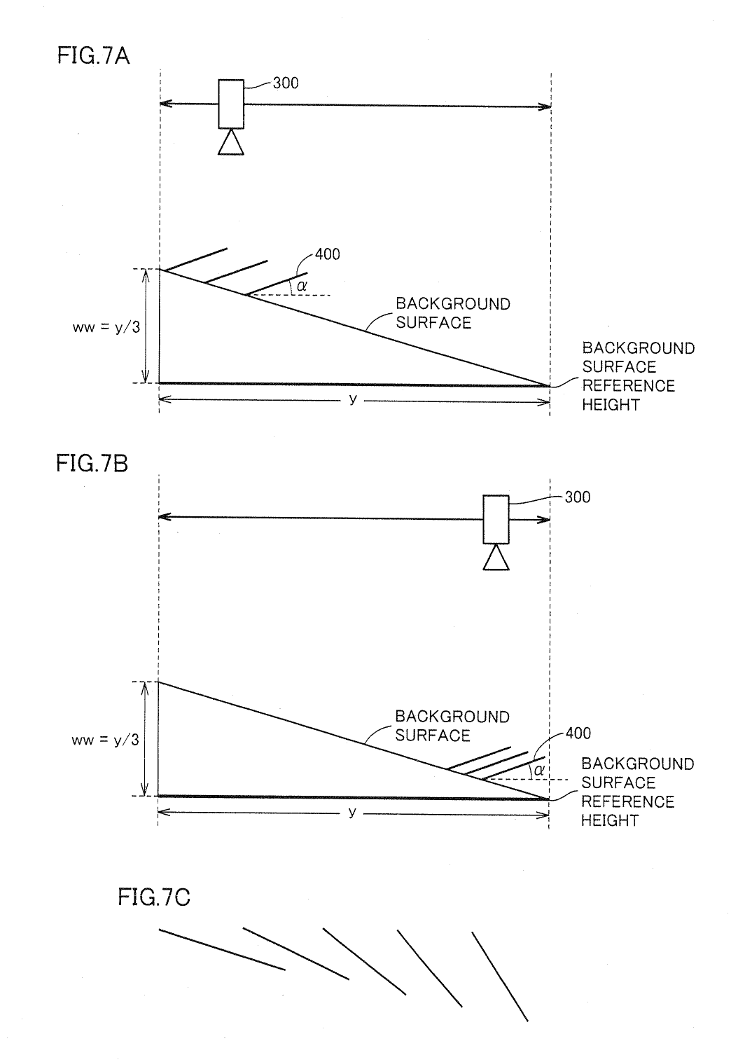

FIGS. 7A and 7B are cross-sectional views of reference surface 430 in virtual space 420, viewed from the direction of X-axis. Here, it is assumed that background image 300 in virtual space 420 has a corresponding length y in the Y-axis direction.

CPU 20 determines at which position on a track (rail) defined by rail data 700 the object 400 is to be placed. By way of example, let us assume that the object is to be placed at coordinates (v, w) on the track defined by rail data 700.

The component w in the Y-axis direction of coordinates (v, w) multiplied by the inclination A of background image 300 is calculated as an amount of correction ww in the Z-axis direction (basic inclination) of the position of placement with respect to background image 300. Specifically,

amount of correction in the Z-axis direction ww=w×A.

The basic inclination ww is corrected, in accordance with the position of stereo virtual camera 410. Assume that the initial position of stereo virtual camera 410 is (x0, y0, z0), and the position at a certain time point is (xc, ye, zc). The correction value in accordance with the position of stereo virtual camera 410 is calculated in the following manner.

Correction value ΔXC in accordance with the camera position in the X-axis direction: ΔXC=(xc−x0)×α

Correction value ΔYC in accordance with the camera position in the Y-axis direction: ΔYC=(yc−y0)×α

Here, α is a factor for eliminating scale difference between the stereoscopic image (right-eye output image 502 and left-eye output image 504) and virtual space 420.

Finally, the amounts of correction in the X-, Y- and Z-axes directions are calculated in the following manner.

Amount of correction in the Z-axis direction ww=w×A

Amount of correction in the X-axis direction wx=ww×ΔXC

Amount of correction in the Y-axis direction wy=ww×ΔYC

The final position where object 400 is to be placed is as follows.

Position of placement (x=v+wx, y=w+wy, z=reference height+ww).

As the inclination of reference surface 430 (or rail data 700 arranged on reference surface 430) is appropriately corrected in accordance with the position of stereo virtual camera 410 as described above, the position, interval, inclination and the like for placing object 400 are appropriately optimized as shown in FIGS. 7A and 7B.

FIG. 7C is a schematic illustration showing how the rail surface (the surface on which the track defined by rail data 700 exists) serving as a reference for placing object 400 is expressed as stereo virtual camera 410 moves. As shown in FIG. 7C, the rail surface is stereoscopically displayed such that as stereo virtual camera 410 comes closer to the upper end of playing field, inclination becomes steeper.

### F. Other Embodiments

Though the camera as the image pick-up device and the display device capable of stereoscopic display are mounted in one housing in game machine 1 described above, these may be provided as separate bodies. Specifically, the image pick-up device (image pick-up means) and the display device (display unit) may be provided as an integrated body or separate bodies.

Further, as shown in FIG. 2, background image 300 (right-eye background image 302 and left-eye background image 304) as two-dimensional stereo image for stereoscopic view and the stereo image (right-eye object image 402 and left-eye object image 404) created by picking-up an image of object 400 placed in virtual space 420 using stereo virtual camera 410 may be created by separate processing bodies, and images may be combined thereafter to realize the stereoscopic display.

While certain example systems, methods, devices, and apparatuses have been described herein, it is to be understood that the appended claims are not to be limited to the systems, methods, devices, and apparatuses disclosed, but on the contrary, are intended to cover various modifications and equivalent arrangements included within the spirit and scope of the appended claims.

What is claimed is:

1. An image display system having access to a display unit capable of stereoscopic display, comprising:
a background setting unit for setting a two-dimensional stereo image for stereoscopic view as a background;
a reference surface setting unit for setting a reference surface in a virtual space such that the reference surface corresponds to a pseudo-surface that appears to exist in said two-dimensional stereo image when said two-dimensional stereo image is stereoscopically displayed;
an object placing unit for placing at least an object on said reference surface;
a stereoscopic image creating unit for creating an image for stereoscopic view, based on a stereo image created by picking-up an image of said object using a stereo virtual camera in said virtual space and on said two-dimensional stereo image; and
a display control unit for causing said display unit to display said image for stereoscopic view.

2. The image display system according to claim 1, further comprising
an object control unit for moving said object on said reference surface.

3. The image display system according to claim 1, wherein
said two-dimensional stereo image is obtained from an image including said pseudo-surface by representing from an oblique direction with respect to said pseudo-surface;
said pseudo-surface appears to be inclined with respect to a display screen of said display unit when said two-dimensional stereo image is stereoscopically displayed; and
said reference surface setting unit is adapted to set said reference surface along the inclination of said pseudo-surface.

4. The image display system according to claim 1, wherein
said two-dimensional stereo image includes an image representing at least one of the ground and a floor.

5. The image display system according to claim 1, wherein
said two-dimensional stereo image is an image picked-up by a stereo camera.

6. The image display system according to claim 1, wherein
said two-dimensional stereo image is an image created by a process of modifying one image.

7. A puzzle game system having access to a display unit capable of stereoscopic display, comprising:
a background setting unit for setting a two-dimensional stereo image for stereoscopic view as a background;
a reference surface setting unit for setting a reference surface in a virtual space such that the reference surface corresponds to a pseudo-surface that appears to exist in said two-dimensional stereo image when said two-dimensional stereo image is stereoscopically displayed;
a game processing unit for placing a plurality of puzzle pieces on said reference surface;
a stereoscopic image creating unit for creating an image for stereoscopic view, based on a stereo image created by picking-up an image of said puzzle pieces using a stereo virtual camera in said virtual space and on said two-dimensional stereo image; and
a display control unit for causing said display unit to display said image for stereoscopic view; wherein
said game processing unit is adapted to erase said puzzle piece in accordance with prescribed progress of the game.

8. An image display method on a display unit capable of stereoscopic display, comprising:
the background setting step of setting a two-dimensional stereo image for stereoscopic view as a background;
the reference surface setting step of setting a reference surface in a virtual space such that the reference surface corresponds to a pseudo-surface that appears to exist in said two-dimensional stereo image when said two-dimensional stereo image is stereoscopically displayed;
the object placing step of placing at least an object on said reference surface;
the stereoscopic image creating step of creating an image for stereoscopic view, based on a stereo image created by picking-up an image of said object using a stereo virtual camera in said virtual space and on said two-dimensional stereo image; and
the display control step of causing said display unit to display said image for stereoscopic view.

9. The image display method according to claim 8, further comprising the object control step of moving said object on said reference surface.

10. The image display method according to claim 8, wherein
said two-dimensional stereo image is obtained from an image including said pseudo-surface by representing from an oblique direction with respect to said pseudo-surface;
said pseudo-surface appears to be inclined with respect to a display screen of said display unit when said two-dimensional stereo image is stereoscopically displayed; and
said reference surface setting step includes the step of setting said reference surface along the inclination of said pseudo-surface.

11. The image display method according to claim 8, wherein
said two-dimensional stereo image includes an image representing at least one of the ground and a floor.

12. The image display method according to claim 8, wherein
said two-dimensional stereo image is an image picked-up by a stereo camera.

13. The image display method according to claim 8, wherein
said two-dimensional stereo image is an image created by a process of modifying one image.

14. A puzzle game method, comprising:
the background setting step of setting a two-dimensional stereo image for stereoscopic view as a background;
the reference surface setting step of setting a reference surface in a virtual space such that the reference surface corresponds to a pseudo-surface in said two-dimensional stereo image that appears to exist when said two-dimensional stereo image is stereoscopically displayed;
the game processing step of placing a plurality of puzzle pieces on said reference surface;
the stereoscopic image creating step of creating an image for stereoscopic view, based on a stereo image created by picking-up an image of said object using a stereo virtual camera in said virtual space and on said two-dimensional stereo image; and
the display control step of causing said display unit to display said image for stereoscopic view; wherein
said game processing step includes the step of erasing said puzzle piece in accordance with prescribed progress of the game.

15. An image display device, comprising:
a display unit capable of stereoscopic display;
a background setting unit for setting a two-dimensional stereo image for stereoscopic view as a background;
a reference surface setting unit for setting a reference surface in a virtual space such that the reference surface corresponds to a pseudo-surface that appears to exist in said two-dimensional stereo image when said two-dimensional stereo image is stereoscopically displayed;
an object placing unit for placing at least an object on said reference surface;
a stereoscopic image creating unit for creating an image for stereoscopic view, based on a stereo image created by picking-up an image of said object using a stereo virtual camera in said virtual space and on said two-dimensional stereo image; and
a display control unit for causing said display unit to display said image for stereoscopic view.

16. A puzzle game device, comprising:
a display unit capable of stereoscopic display;
a background setting unit for setting a two-dimensional stereo image for stereoscopic view as a background;
a reference surface setting unit for setting a reference surface in a virtual space such that the reference surface corresponds to a pseudo-surface that appears to exist in said two-dimensional stereo image when said two-dimensional stereo image is stereoscopically displayed;
a game processing unit for placing a plurality of puzzle pieces on said reference surface;
a stereoscopic image creating unit for creating an image for stereoscopic view, based on a stereo image created by picking-up an image of said puzzle pieces using a stereo virtual camera in said virtual space and on said two-dimensional stereo image; and
a display control unit for causing said display unit to display said image for stereoscopic view; wherein
said game processing unit is adapted to erase said puzzle piece in accordance with prescribed progress of the game.

17. A non-transitory storage medium encoded with a computer-readable image display program and executable by a computer having access to a display unit capable of stereoscopic display, causing said computer to execute
the background setting step of setting a two-dimensional stereo image for stereoscopic view as a background;
the reference surface setting step of setting a reference surface in a virtual space such that the reference surface corresponds to a pseudo-surface that appears to exist in said two-dimensional stereo image when said two-dimensional stereo image is stereoscopically displayed;
the object placing step of placing at least an object on said reference surface;
the stereoscopic image creating step of creating an image for stereoscopic view, based on a stereo image created by picking-up an image of said object using a stereo virtual camera in said virtual space and on said two-dimensional stereo image; and
the display control step of causing said display unit to display said image for stereoscopic view.

18. A non-transitory storage medium encoded with a computer-readable puzzle game program and executable by a computer having access to a display unit capable of stereoscopic display, causing said computer to execute
the background setting step of setting a two-dimensional stereo image for stereoscopic view as a background;
the reference surface setting step of setting a reference surface in a virtual space such that the reference surface corresponds to a pseudo-surface that appears to exist in said two-dimensional stereo image when said two-dimensional stereo image is stereoscopically displayed;
the game processing step of placing a plurality of puzzle pieces on said reference surface;
the stereoscopic image creating step of creating an image for stereoscopic view;
based on a stereo image created by picking-up an image of said object using a stereo virtual camera in said virtual space and on said two-dimensional stereo image; and
the display control step of causing said display unit to display said image for stereoscopic view; wherein
said game processing step includes the step of erasing said puzzle piece in accordance with prescribed progress of the game.
